(19) United States
(12) Patent Application Publication
(10) Pub. No.: US 2026/0147827 A1
(43) Pub. Date: May 28, 2026

(54) OPEN VOCABULARY VQA FOR SATELLITE IMAGERY

(71) Applicant: NEC Laboratories America, Inc., Princeton, NJ (US)

(72) Inventors: Biplob Debnath, Princeton, NJ (US); Murugan Sankaradas, Dayton, NJ (US); Ravi Kailasam Rajendran, Colonia, NJ (US); Srimat Chakradhar, Manalapan, NJ (US); Md Adnan Arefeen, Kansas City, MO (US)

(21) Appl. No.: 19/398,414

(22) Filed: Nov. 24, 2025

Related U.S. Application Data
(60) Provisional application No. 63/725,779, filed on Nov. 27, 2024.
(60) Provisional application No. 63/775,544, filed on Mar. 21, 2025.

(51) Int. Cl. G06F 16/532; G06F 16/535; G06F 16/56

(52) U.S. Cl. CPC G06F 16/532; G06F 16/535; G06F 16/56

(57) ABSTRACT

Methods and systems for question answering include generating a tile from an image and encoding the tile to generate an embedding vector. A set of neighbor objects is generated based on an object of interest from a query. A first similarity is determined between the object of interest and the embedding vector of the tile. Second similarities are determined between the neighbor objects and the embedding vector of the tile. It is determined that the tile is relevant responsive to the first similarity being greater than the second similarities. The query is answered using the tile.

### RELATED APPLICATION INFORMATION

This application claims priority to U.S. Patent Application No. 63/725,779, filed on Nov. 27, 2024, and to U.S. Patent Application No. 63/775,544, filed on Mar. 21, 2025, each incorporated herein by reference in its entirety.

### BACKGROUND

### Technical Field

The present invention relates to visual question answering (VQA) and, more particularly to open vocabulary VQA.

### Description of the Related Art

When using a language model to answer questions about an image, a user's queries may take the form of open-ended natural language that extends beyond a fixed set of predefined categories. Visual language models (VLMs) may be used for text-image retrieval, but even fine-tuned models may struggle when answering queries about images with viewpoints that differ significantly from their bulk of their training data.

### SUMMARY

A method for question answering includes generating a tile from an image and encoding the tile to generate an embedding vector. A set of neighbor objects is generated based on an object of interest from a query. A first similarity is determined between the object of interest and the embedding vector of the tile. Second similarities are determined between the neighbor objects and the embedding vector of the tile. It is determined that the tile is relevant responsive to the first similarity being greater than the second similarities. The query is answered using the tile.

A system for question answering includes a hardware processor and a memory that stores a computer program. When executed by the hardware processor, the computer program causes the hardware processor to generate a tile from an image and to encode the tile to generate an embedding vector, to generate a set of neighbor objects based on an object of interest from a query, to determine a first similarity between the object of interest and the embedding vector of the tile, to determine second similarities between the neighbor objects and the embedding vector of the tile, to determine that the tile is relevant responsive to the first similarity being greater than the second similarities, and to answer the query using the tile.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a question answering system that refines user queries for satellite imagery, in accordance with an embodiment of the present invention;

FIG. 2 is a block/flow diagram of a method for question answering for satellite imagery, in accordance with an embodiment of the present invention;

FIG. 3 is a block/flow diagram of a method for identifying tiles in a satellite image that are relevant to a query, in accordance with an embodiment of the invention;

FIG. 4 is a block/flow diagram of a method for refining a user's query, in accordance with an embodiment of the present invention;

FIG. 5 is an example of how a satellite image may be split into tiles, in accordance with an embodiment of the present invention;

FIG. 6 is a block diagram of a computing device that can perform query refinement and question answering, in accordance with an embodiment of the present invention;

FIG. 7 is a diagram of an exemplary neural network architecture that can be used to implement part of a visual language model, in accordance with an embodiment of the present invention; and

FIG. 8 is a diagram of an exemplary deep neural network architecture that can be used to implement part of a visual language model, in accordance with an embodiment of the present invention.

### DETAILED DESCRIPTION OF PREFERRED EMBODIMENTS

Alignment between user queries and image content may be improved using a training-free query embedding that operates at inference time. Visual language models (VLMs) may be used to compute embeddings for image tiles. When executing a query, large language models (LLMs) may be used to refine the text embeddings by incorporating contextual information about objects of interest and their surroundings. A threshold-free retrieval mechanism further enhances accuracy and efficiency.

For example, satellite image data may include high-resolution, multi-modal imagery that provides valuable data for various applications. These images are captured at varying spatial resolutions from low-resolutions (e.g., about 30 m/pixel) to relatively high resolutions (e.g., less than about 1 m/pixel), and future advancements in satellite technologies will tend to increase these resolutions. Modern satellite systems offer frequent revisit rates, enabling high-frequency monitoring of environmental and anthropogenic changes.

While the present principles may be applied to any appropriate type of data, satellite imagery poses challenges for existing models for existing VLMs. Handling open-vocabulary queries in particular may be challenging. For example, a user might pose a query, “How many residential houses have solar panels installed?” or “Find construction sites.” Users might also inquire about specific objects, such as building or vegetation types.

Satellite images may span large geographic areas and may render objects, such as cars, buildings, or trees, with only a few pixels. Detecting these small objects may use specialized methods capable of managing substantial scale variations while preserving precision at low resolutions. Small object detection models may suffer from their rigid design when it comes to answering questions about new object categories. This inflexibility becomes a problem when handling user queries that involve unseen or novel objects. In the context of satellite imagery, where the range of potential queries is large, these constraints hinder effective analysis and user engagement. The large size of satellite images calls for efficient extraction of pertinent information from targeted regions.

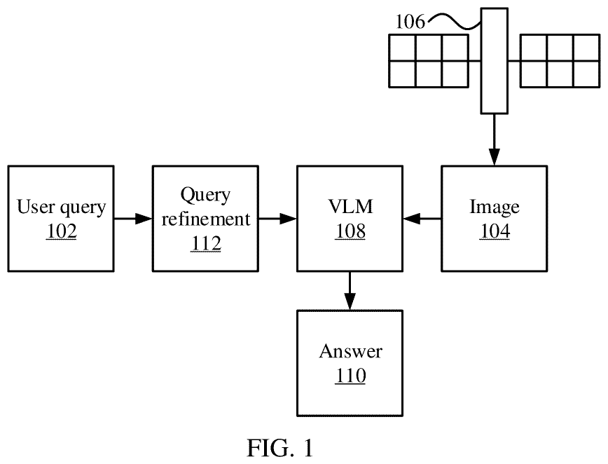

Referring now to FIG. 1, an exemplary VQA system is shown. A user query 102 poses a question relating to an image 104. In this example the image 104 is captured by a satellite, but it should be understood that the present principles may be applied to any appropriate image, regardless of its source.

A VLM 108 processes the user's query 102 based on the image 104 and generates an answer 110. The VLM 108 is trained to identify semantic information in the user's query 102 and the image 104 and relates the semantic information from these two different sources to generate the answer 110. For example, a text embedding of the user query 102 may capture the fact that the user is asking about buildings, and an image embedding of the image 104 may indicate that the image 104 includes buildings.

The VLM 108 may first identify relevant tiles within the image 104, before processing the relevant tiles to generate accurate responses. Objects of interest within the user query 102 may be identified to indicate whether a given tile is relevant. However, this approach is computationally expensive, as locating the object may include running object detection on each of the tiles. This challenge becomes more pronounced with larger satellite images that have more tiles. In addition, when the vocabulary of the user query 102 is different from what was used to train the VLM 108, the VLM may have difficulty identifying the corresponding features of the image 104.

The VLM 108 begins by generating embeddings for each tile of the image 104. These embeddings, along with their corresponding tile images, may be stored in a vector database to enable efficient query-agnostic retrieval. The embedding of the user query 102 may then be used to perform retrieval of tiles, using a similarity metric to identify tiles that have an above-threshold similarity score with the user query 102.

A further challenge is that a given tile may include multiple objects. For example, a tile that shows a river among its elements will likely also have non-river elements around it, making it difficult to retrieve all relevant tiles. To address this, surrounding objects that are related to an object of interest may be identified using an LLM. A tile is considered relevant if its embedding is more similar to the text embedding of the object of interest than to the text embeddings of surrounding objects. Information about the surrounding objects may be used to create more accurate text embeddings in query refinement 112. This improves the accuracy of finding the relevant tiles.

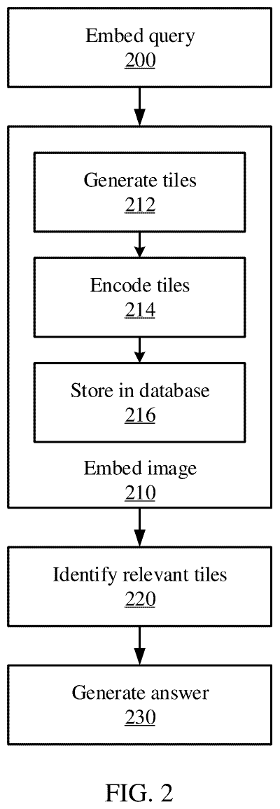

Referring now to FIG. 2, a method of performing question answering on an image is shown. Block 200 embeds the user query 102 using an encoder, such as in an LLM. Block 200 embeds the user query 102 using, for example, an LLM to encode the text of the user query 102 in a latent semantic space.

Block 210 embeds the image 104 in a same latent semantic space, for example using VLM 108. This process includes generating tiles in block 212 by dividing the image 104 into smaller parts. Satellite images cover large geographic areas. To extract fine-grained details, a sliding window may be used to divide the image 104 into tiles of a predetermined size (e.g., 224×224 pixels). Block 214 may then encode the tiles into the latent semantic space, generating respective vectors that block 216 stores in a database, each with its respective tile. This maps each tile to its embedding for future reference.

Block 220 identifies relevant tiles from the database using the embedded query, for example using a similarity metric to compare the vector of the embedded query to stored vectors in the database. Any tile vector that has an above-threshold similarity to the embedded query vector may be regarded as relevant. The similarity metric may use any appropriate function, such as the cosine similarity. Upon retrieval, the VLM 108 may extract objects of interest (e.g., “construction site” from the query, “Find construction sites.”). The object's embedding may then be determined using the same image-text embedding model. The relevant tiles may be further processes by other models, such as an LLM, to generate the final answer in block 230.

Two parameters that affect the performance of this process are the similarity threshold for block 220 and the generation of accurate text embeddings in block 200. The similarity threshold controls how many tiles are included, and setting the threshold too high may exclude tiles that include partially relevant information, while a threshold that is too lose can introduce noise in less relevant tiles. Generating robust text embeddings includes capturing the nuances of natural language queries to accurately represent the object of interest. This is important when comparing query embeddings with tile embeddings, to ensure that the system retrieves the most relevant tiles to use when generating the answer.

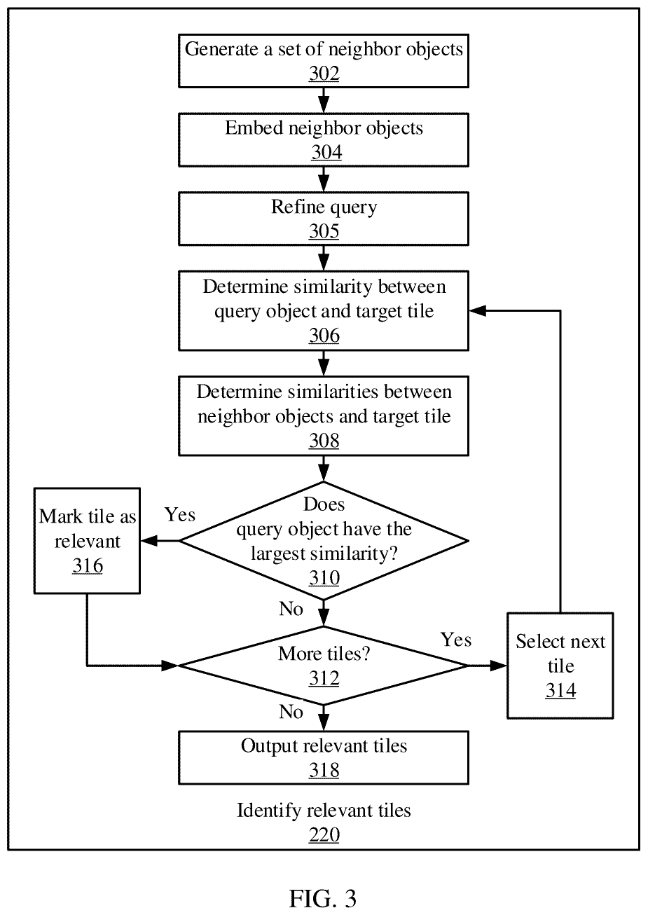

Referring now to FIG. 3, additional detail on block 220 is shown. Rather than using a threshold, block 220 may compare the similarity between the user query 102 and a given tile to the similarities of its nearest neighbors. The nearest neighbors refer to objects seen alongside the object of interest, for example from a satellite's perspective, and may include surrounding or contextually related objects.

This approach to determining relevance transforms the problem from a threshold-based selection into a threshold-free, classification-like task. For each tile, block 220 calculates its embedding similarity with both the object of interest and its neighboring objects. The maximum similarity score may then be used to classify the current tile. If the object of interest achieves the highest similarity, the tile is selected for further analysis. Otherwise it is discarded. However, the question of how to determine the nearest neighbors remains.

Thus, block 302 takes an object from the user query 102 and generates a set of neighbor objects, for example prompting an LLM to first extract the object of interest from the user query 102 and to generate a set of objects that may typically be observed alongside the object of interest in, e.g., satellite imagery. Block 304 embeds each of these neighbor objects to generate respective vectors in the latent semantic space. As will be described in greater detail below, block 305 refines the user's query 102 using the neighbor objects.

Block 306 uses the similarity metric to determine the similarity between the object from the user's query 102 and the embedding vector of a target tile stored in the database. Block 308 uses the similarity metric to determine the similarity between the neighbor objects and the embedding vector. As discussed above, this similarity may include a cosine similarity or any other appropriate metric.

Block 310 determines whether the similarity between query object and the embedding vector of the target tile is larger than the similarities of the neighbor objects to the embedding vector of the target tile. If so, block 316 marks the tile as relevant. Block 312 determines whether there are more tiles from the image 104 to consider. If so, block 314 selects a next tile and processing returns to block 306. If not, block 318 outputs a list of the tiles which were marked relevant by block 316.

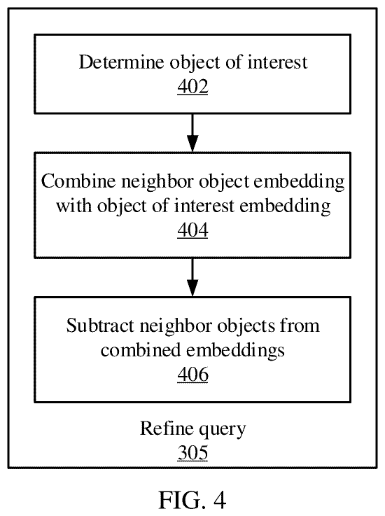

Referring now to FIG. 4, additional detail is provided regarding the query refinement in block 305. Although the process of FIG. 3 eliminates the need for a threshold, overlapping similarity distributions between text embeddings of an object of interest and its surrounding objects still pose a challenge. In most satellite images, tiles often contain multiple objects rather than a single one. For example, a satellite tile of a river may include roads, mountains, bridges, forests, and more. As the object of interest identified through open vocabulary searches from the user changes, the neighbor objects determined by block 304 may also change.

To enhance retrieval accuracy, a modification layer may be applied after computing the text embedding of the object in block 200. Text embedding modification makes use of the vector difference of lexical relations. Instead of directly using the embeddings as a representative for the user's query 102, the query may be modified to improve retrieval accuracy. After identifying the object of interest and its neighbor objects using an LLM, the text embedding of the object may be determined by block 402.

For each surrounding object, its embedding may be combined with the embedding of the object of interest in block 404. This composition effect accounts for the influence of surrounding objects on the object of interest by computing the combined text embedding of, e.g., “a satellite photo of {object-of-interest} with {surrounding object}.” To reduce redundancy, the effect of the neighbor objects may be subtracted from the query by computing the text embedding of, “a satellite photo of a {surrounding object}” and subtracting it from the combined embedding in block 406. The result is treated as the refined embedding for the object of interest.

Stated formally, Tₓ is the text embedding of the query, “A satellite photo of {object x},” T_{yi} is the text embedding of the query, “A satellite photo of {surrounding object yᵢ}” and T_{x,yi} is the text embedding of, “A satellite photo of {object x} with {surrounding object yᵢ}”. All embeddings are produced by the same text encoder to ensure that they lie in a shared semantic space. The modified embedding for the i^{th} surrounding object yᵢ is defined as:

$${T}_{x , i}^{′} = {T}_{x} + α {T}_{x , {y}_{i}} - β {T}_{{y}_{i}}$$

where α and β are weighting coefficients that control the contribution of the contextual and background objects. This can be viewed as a semantic adjustment to the base text embedding Tₓ. The term α determines how much to integrate the joint context—how strongly to emphasize the “object-in-context” semantics. The term β controls how much to subtract or discount the surrounding object itself, preventing the embedding from over-representing background features. Larger α values make the representation more context-aware, capturing the interaction between the object and its surroundings. In contrast, larger β values make it more object-focused, filtering out irrelevant contextual signals. The coefficients can be set as hyperparameters or optimized as learnable weights. The surrounding objects are generated automatically by an LLM given the object of interest. For each surrounding object, the query embedding is updated as in

$${T}_{x}^{″} = \frac{{\sum }_{i = 1}^{n} {T}_{x , i}^{′}}{n}$$

The final refined embedding is the average of these adjusted vectors:

$${T}_{x , i}^{′} .$$

Here n is the number of surrounding objects.

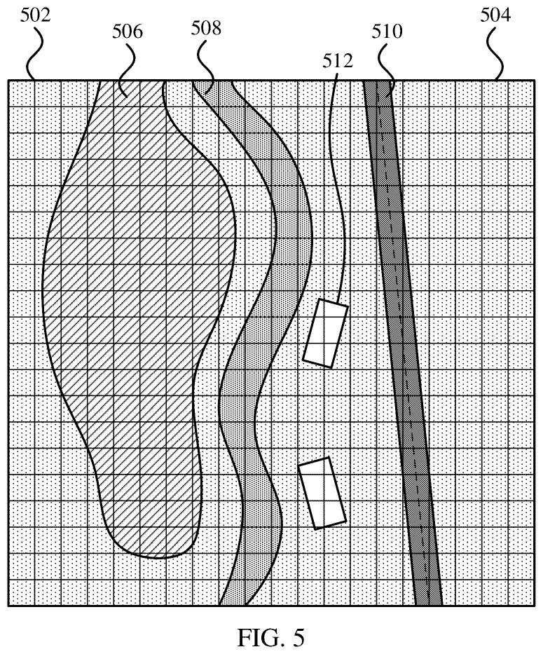

Referring now to FIG. 5, an example satellite image 502 is shown. The image 502 is broken into tiles 504. Although the tiles 504 are shown as occupying distinct portions of the image 502, it should be understood that the tiles 504 may alternatively be defined with a sliding window.

The image 502 includes a variety of images, including wooded areas 506, a body of water 508, a road 510, and buildings 512. In some cases an object may occupy multiple tiles 504, and in other cases a single tile 504 may include multiple objects. Each of the tiles 504 may be embedded into a semantic latent space to generate a corresponding vector that indicates the contents of the tile. The tiles 504 may be stored in a database along with their corresponding embedding vectors for later retrieval and comparison.

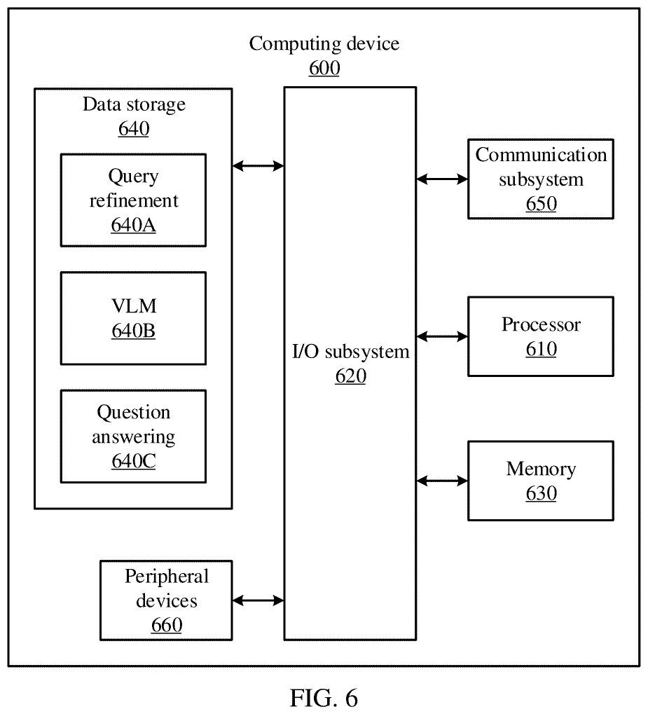

Referring now to FIG. 6, an exemplary computing device 600 is shown, in accordance with an embodiment of the present invention. The computing device 600 is configured to perform visual question answering.

The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for query refinement, 640B for a VLM, and/or 640C for question answering. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

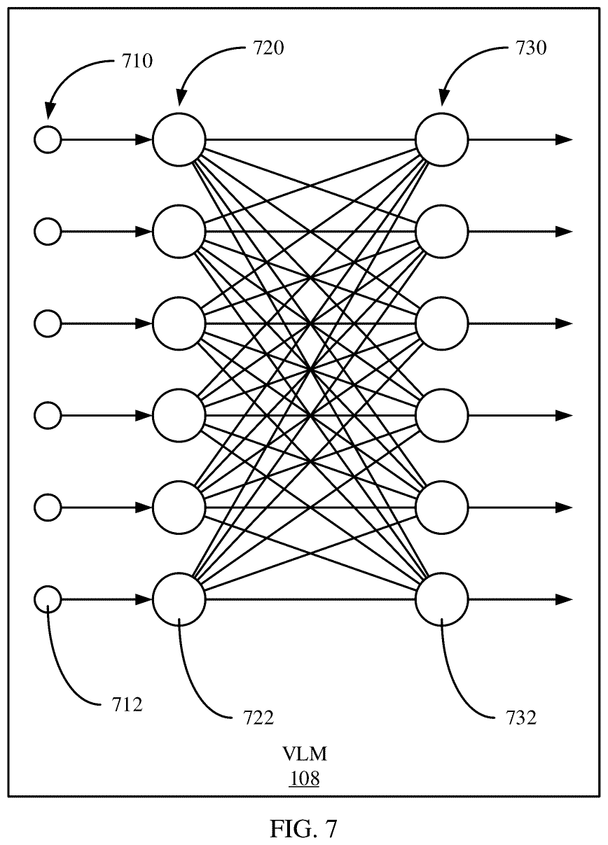

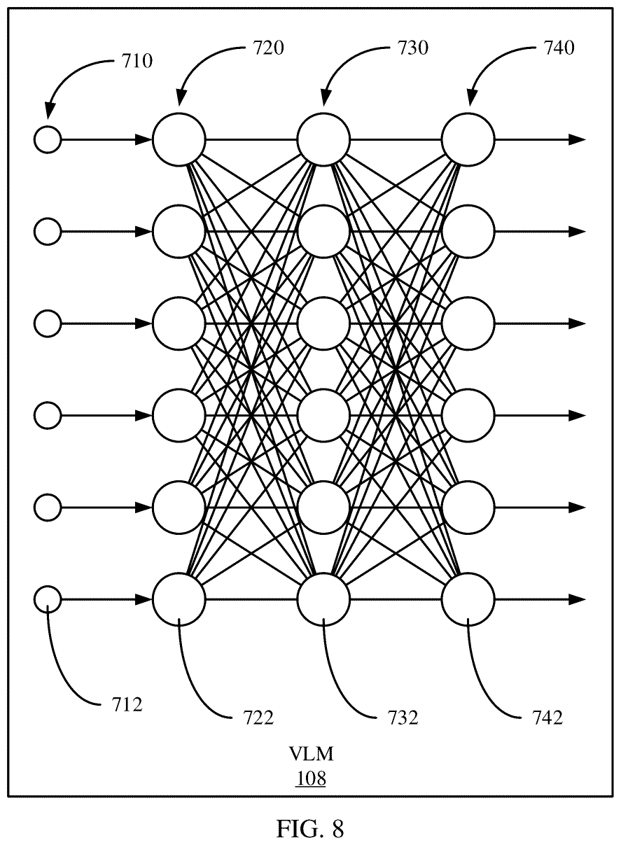

Referring now to FIGS. 7 and 8, exemplary neural network architectures are shown, which may be used to implement parts of the present machine learning models, such as the VLM 108. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more 6
computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for question answering, comprising:
generating a tile from an image;
encoding the tile to generate an embedding vector;
generating a set of neighbor objects based on an object of interest from a query;
determining a first similarity between the object of interest and the embedding vector of the tile;
determining second similarities between the neighbor objects and the embedding vector of the tile;
determining that the tile is relevant responsive to the first similarity being greater than the second similarities; and
answering the query using the tile.

2. The method of claim 1, wherein generating the tile includes generating a plurality of tiles and encoding generates a plurality of respective embedding vectors for the plurality of tiles.

3. The method of claim 2, wherein determining the first similarity and determining the second similarities are repeated for the plurality of respective embedding vectors.

4. The method of claim 3, wherein determining that the tile is relevant determines that only those tiles where the first similarity is greater than the second similarities are relevant.

5. The method of claim 4, wherein answering the query uses all of the relevant tiles.

6. The method of claim 1, further comprising refining the query before determining the first similarity.

7. The method of claim 6, wherein refining the query includes combining a neighbor object embedding vector with an object of interest embedding vector to generate a combined vector.

8. The method of claim 7, wherein refining the query further includes subtracting the neighbor object embedding vector from the combined vector.

9. The method of claim 1, wherein generating the set of neighbor objects includes prompting a language model to generate a set of objects that are typically located near the object of interest in satellite images.

10. The method of claim 1, wherein the query is a natural language query asking for information about contents of the image, and wherein the image is a satellite image.

11. A system for question answering, comprising:
a hardware processor; and
a memory that stores a computer program which, when executed by the hardware processor, causes the hardware processor to:
generate a tile from an image;
encode the tile to generate an embedding vector;
generate a set of neighbor objects based on an object of interest from a query;
determine a first similarity between the object of interest and the embedding vector of the tile;
determine second similarities between the neighbor objects and the embedding vector of the tile;
determine that the tile is relevant responsive to the first similarity being greater than the second similarities; and
answer the query using the tile.

12. The system of claim 11, wherein generation of the tile includes generation of a plurality of tiles and encoding of the tile generates a plurality of respective embedding vectors for the plurality of tiles.

13. The system of claim 12, wherein determination of the first similarity and determination of the second similarities are repeated for the plurality of respective embedding vectors.

14. The system of claim 13, wherein determination that the tile is relevant determines that only those tiles where the first similarity is greater than the second similarities are relevant.

15. The system of claim 14, wherein answering of the query uses all of the relevant tiles.

16. The system of claim 11, wherein the computer program further causes the hardware processor to refine the query before determination of the first similarity.

17. The system of claim 16, wherein refining the query includes combining a neighbor object embedding vector with an object of interest embedding vector to generate a combined vector.

18. The system of claim 17, wherein refining the query further includes subtracting the neighbor object embedding vector from the combined vector.

19. The system of claim 11, wherein generating the set of neighbor objects includes prompting a language model to generate a set of objects that are typically located near the object of interest in satellite images.

20. The system of claim 11, wherein the query is a natural language query asking for information about contents of the image, and wherein the image is a satellite image.
